(19) United States
(12) Patent Application Publication
(10) Pub. No.: US 2023/0202141 A1
(43) Pub. Date: Jun. 29, 2023

(54) VACUUM INSULATION ELEMENT

(71) Applicant: va-Q-tec AG, Würzburg (DE)

(72) Inventors: Tobias Bock, Kitzingen (DK); Sebastian Gralla, Würzburg (DE); Kenny Rottenbacher, Würzburg (DE); Joachim Kuhn, Würzburg (DE)

(21) Appl. No.: 18/069,745

(22) Filed: Dec. 21, 2022

(30) Foreign Application Priority Data
Dec. 23, 2021 (DE) 20 2021 107 040.4

(51) Int. Cl. B32B 15/08; E04B 1/80; B32B 3/18; B32B 15/18; B32B 37/06

(52) U.S. Cl. CPC B32B 15/08; E04B 1/803; B32B 3/18; B32B 15/18; B32B 37/06; B32B 2250/02; B32B 2305/026; B32B 2307/31

(57) ABSTRACT

The present invention pertains to a vacuum insulation element suitable as a fire protection insulation element, comprising a core material and an envelope completely surrounding the core material, said envelope comprising a plastics layer and a stainless steel layer disposed on the plastics layer.

### CROSS-REFERENCE TO RELATED APPLICATIONS

This patent application claims priority to German utility patent application number 20 2021 107 040.4 filed Dec. 23, 2021 and titled “vacuum insulation element”. The subject matter of patent application number 20 2021 107 040.4 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention pertains to a vacuum insulation element, suitable as a fire protection insulation element, according to the independent claim.

### BACKGROUND

In conventional vacuum insulation elements, which are often designed as vacuum insulation panels, a pressure-resistant core material, for example of fumed silica, is wrapped with a vacuum-tight envelope. A multilayer metallized plastics foil, which is designed as a high-barrier foil, is usually used as the envelope. The core material is introduced into the envelope, whereupon the envelope is evacuated and sealed in a vacuum-tight manner. Such a vacuum insulation element exhibits excellent thermal insulation properties compared to other insulation sheet materials due to the vacuum generated therein. In particular, the reduced convection within the vacuum insulation element as a result of evacuation contributes to the enhanced thermal insulation properties.

Such vacuum insulation elements are employed in various technical applications, such as thermal insulation elements in transport containers or boxes for temperature-controlled transport or in the field of building materials, for example for thermal insulation of ceilings and walls. Compared to many other insulating elements, vacuum insulation elements often take up significantly less space to allow rendering of the same thermal insulation performance.

In the applications of vacuum insulation elements, special requirements are often placed on preventive fire protection properties of the vacuum insulation element, for instance in the case of battery insulation, insulation materials in rail and air traffic, etc.

In the building sector, these requirements are defined in the form of building material classes.

Commonly used vacuum insulation elements typically do not meet the requirements for building material class B2 according to DIN 4102-1 or Euroclass E according to EN 13501-1. This is mainly due to the fact that the envelope of the vacuum insulation elements described consists of an easily combustible, multilayer metallized plastics material. However, this sort of envelope is commonly used because it provides a low permeation rate for maintaining a vacuum over a long period of time, and can also be easily sealed by thermal welding with seams. Fire-retardant substances applied onto the envelope can be used to attain a higher fire protection class, but vacuum insulation elements, even those having a non-combustible core material, typically do not meet the requirements for fire protection class A2 according to DIN 4102-1 or EN 13501-1

Furthermore, for example from WO 9601346 A1, it is known to provide a vacuum insulation panel with a stainless steel casing. In this process, an upper part and a lower part made of stainless steel are welded together to hermetically seal the intermediate space. Several layers of glass fiber mats are arranged in the core of this vacuum insulation panel.

A similar technique is disclosed in WO 2018 043712 A1, wherein a vacuum insulation panel is provided with a steel casing. Again, the core material consists of a fiber material.

These vacuum insulation panels, although non-combustibility is provided, are complex to manufacture. In addition, the high thermal conductivity of the pure stainless steel casing is also disadvantageous.

### SUMMARY

It is the object of the present invention to eliminate the disadvantages of the prior art and to provide a vacuum insulation element with enhanced fire protection properties to enable use as a fire protection insulation element. This object is attained by a vacuum insulation element according to the independent claim. Advantageous aspects form the subject-matter of the respective subclaims.

The invention encompasses a vacuum insulation element suitable as a fire protection insulation element, comprising a core material and an envelope completely surrounding the core material, the envelope comprising a plastics layer and a stainless steel layer disposed on the plastics layer.

In this regard, the core material can comprise fumed silica and/or a fiber material. The combination of the plastics layer and the stainless steel layer for forming the envelope renders the vacuum insulation element suitable as a fire protection insulation element. In addition, the combination of the plastics layer and the stainless steel layer reduces the occurrence of thermal bridges between the environment of the vacuum insulation element and the core material and at the seams of the envelope.

### BRIEF DESCRIPTION OF THE DRAWINGS

In the following, the invention will be explained in greater detail with reference to drawings, wherein:

FIG. 1 shows a schematic view of a vacuum insulation element; and;

FIG. 2 shows a schematic view of a vacuum insulation element; and

FIG. 3 shows a schematic sectional view of an envelope.

### DETAILED DESCRIPTION

According to an advantageous aspect, the stainless steel layer comprises a stainless steel foil. Here, the stainless steel foil is coated with the plastics layer. Stainless steel foils are available in suitable thicknesses and can be easily coated with a plastics layer, for example polyethylene. Designing the stainless steel layer as a stainless steel foil is advantageous over metallizing the plastics layer, since the stainless steel foil is less sensitive to mechanical stress compared to the metallized plastics layer.

According to another advantageous aspect, the stainless steel layer comprises a stainless steel foil, and the plastics layer comprises a plastics foil. In this context, the stainless steel foil is indirectly or directly laminated onto the plastics foil. In this regard, the process of laminating provides a low-cost and rapid bonding technique. In this process, the stainless steel foil and the plastics foil can be bonded using an adhesive or by carrying out thermal lamination.

According to a preferred aspect, the envelope has a thickness which is configured such that the envelope is flexible. A flexible envelope offers the advantage that folded edges can be formed.

According to a particularly advantageous aspect, the stainless steel layer has a thickness in a range between 20 μm to 80 μm, in particular 30 μm and 40 μm. This provides the advantage that the vacuum insulation element does not become too stiff and thus allows a more flexible handling.

According to another preferred aspect, the stainless steel layer has a smaller thickness than the plastics layer. This makes it possible to achieve a low weight of the envelope.

According to a preferred aspect, the plastics layer has a thickness in a range between 50 μm and 100 μm. In this regard, the plastics layer can be designed as a high barrier layer such that the plastics layer has a low permeation rate despite the low thickness, which is suitable for ensuring that a pressure of <1 mbar can be generated and maintained inside the vacuum insulation element.

According to another preferred aspect, the plastics layer is made of a heat-sealable material. This allows the creation of seams by thermal welding of the plastics layer. Another option would be the use of an ultrasonically weldable material.

According to a particularly preferred aspect, the envelope comprises at least one seam created by thermally welding the plastics layer to the stainless steel layer. The aspect that the envelope is a combination of a plastics layer and a stainless steel layer disposed on the plastics layer, makes it possible that thermal welding for seam creation can be easily performed.

According to another preferred aspect, the envelope has a permeation rate for air in a range between 0-2 mbarl/m²y at ambient conditions and for water vapor in a range between 0-0.004 g/m²d at 50° C., 70% RH.

According to a particularly preferred aspect, the vacuum insulation element comprises a combustible core material. In this context, the envelope is designed in such a way that the vacuum insulation element meets the minimum requirements for fire class B2 according to DIN 4102-1 or E according to EN 13501-1. Thereby, the stainless steel layer of the envelope is formed so as to prevent burning of the core material.

According to an advantageous aspect, the vacuum insulation element comprises a non-combustible core material. In this context, the envelope is designed in such a way that the vacuum insulation element meets the minimum requirements for fire class A2 according to DIN 4102-1 or EN 13501-1.

According to a particularly advantageous aspect, the core material comprises a solid core or a pulverulent core or an open-pored core. An open-pored core can thereby comprise fumed silica. A solid core can thereby comprise a fiber material.

According to a preferred aspect, the core material comprises glass fibers. Glass fibers and other fiber materials can thereby increase the stability of the vacuum insulation element. According to one variant, the core material made of plastics comprises plastics powder in loose or compressed form and foamed plastics.

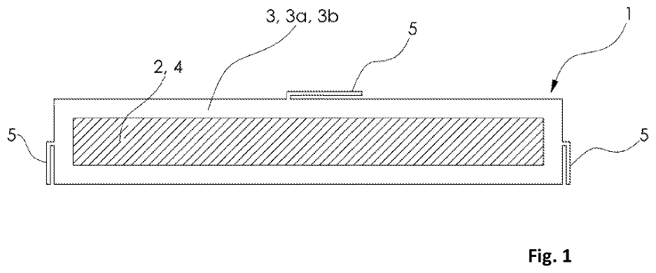

FIG. 1 shows one variant for a vacuum insulation element 1. The vacuum insulation element 1 shown is formed as a vacuum insulation panel with a center seam. The vacuum insulation element 1 comprises a core material 2, and an envelope 3 completely surrounding the core material 2 and made of various sections connected to each other. The envelope 3 comprises a plastics foil 3a and a stainless steel foil 3b.

The seams 5 extend along the sides at about half height, and along the flat side of the vacuum insulation panel.

The core material 2 in the illustrated embodiment comprises fumed silica, glass fibers 4 or a loose plastics material.

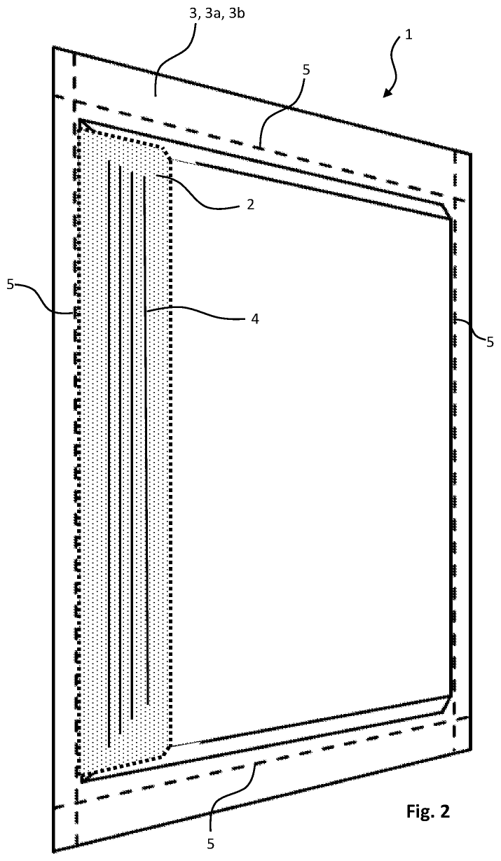

FIG. 2 shows a schematic view of a vacuum insulation element 1. The vacuum insulation element 1 shown is embodied as a vacuum insulation panel. The vacuum insulation element 1 comprises a core material 2 and an envelope 3 completely surrounding the core material 2. The envelope 3 comprises a plastics foil 3a and a stainless steel foil 3b, which are bonded to each other by lamination. Here, the stainless steel foil 3b has a thickness of 40 μm and the plastics foil 3a has a thickness of 100 μm. This means that the vacuum insulation element 1 is not too stiff and allows a more flexible handling, as well as the creation of folded edges.

The plastics foil 3a is formed here as a high barrier layer such that the plastics layer 3a has a low permeation rate despite the low thickness, which is suitable for ensuring that a pressure of <1 mbar can be generated and maintained inside the vacuum insulation element.

The use of a combination of plastics foil 3a made of a heat-sealable material and a stainless steel foil 3b allows seams 5 to be easily created by thermal welding. At the same time, the combination of plastics foil 3a and stainless steel foil 3b as the envelope 3 contributes to rendering the vacuum insulation element 1 suitable as a fire protection insulation element.

The use of a combination of plastics foil 3a and stainless steel foil 3b is advantageous over metallization of the plastics foil 3a, because the stainless steel foil 3b is less sensitive to mechanical stress compared to a metallized plastics layer.

The core material 2 in the illustrated embodiment comprises fumed silica and glass fibers 4. The combination of plastics foil 3a and stainless steel foil 3b as the envelope 3 reduces the occurrence of thermal bridges between the environment of the vacuum insulation element 1 and the core material 2.

A vacuum insulation element 1 according to the invention of the illustrated embodiment meets the requirements according to DIN 4102-1 and EN 13501-1 for fire protection class A2.

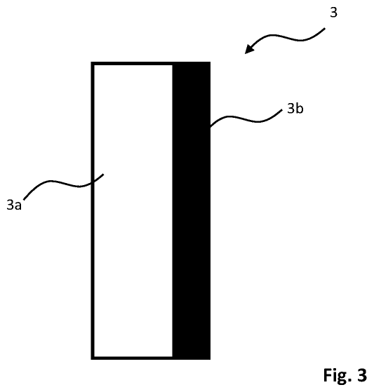

FIG. 3 shows a section through the envelope 3. Here, the envelope 3 comprises a plastics foil 3a and a stainless steel foil 3b. In this aspect, the plastics foil 3a and a stainless steel foil 3b are bonded together by lamination.

What is claimed is:

1. Vacuum insulation element suitable as a fire protection insulation element, comprising a core material, and an envelope completely surrounding the core material, said envelope comprising a plastics layer and a stainless steel layer disposed on the plastics layer.

2. Vacuum insulation element according to claim 1, wherein the stainless steel layer comprises a stainless steel foil, and wherein the stainless steel foil is coated with the plastics layer

3. Vacuum insulation element according to claim 1, wherein the stainless steel layer comprises a stainless steel foil, and wherein the plastics layer comprises a plastics foil, and wherein the stainless steel foil is indirectly or directly laminated onto the plastics foil.

4. Vacuum insulation element according to claim 1, wherein the envelope has a thickness which is configured such that the envelope is flexible.

5. Vacuum insulation element according to claim 1, wherein the stainless steel layer has a thickness in a range between 20 μm to 80 μm, in particular 30 μm and 40 μm.

6. Vacuum insulation element according to claim 1, wherein the stainless steel layer has a smaller thickness than the plastics layer.

7. Vacuum insulation element according to claim 1, wherein the plastics layer has a thickness in a range between 50 μm and 100 μm.

8. Vacuum insulation element according to claim 1, wherein the plastics layer is made of a heat-sealable or ultrasonically weldable material.

9. Vacuum insulation element according to claim 8, wherein the envelope has at least one seam created by thermal welding of the plastics layer to the stainless steel layer.

10. Vacuum insulation element according to claim 1, comprising a combustible core material, and wherein the envelope is designed such that the vacuum insulation element meets the minimum requirements for fire class B2 according to DIN 4102-1 or E according to 13501-1.

11. Vacuum insulation element according to claim 1, comprising a non-combustible core material, and wherein the envelope is designed such that the vacuum insulation element meets the minimum requirements for fire class A2 according to DIN 4102-1 or EN according to 13501-1.

12. Vacuum insulation element according to claim 1, wherein the core material comprises a solid core or a pulverulent core or an open-pored core.

13. Vacuum insulation element according to claim 1, wherein the core material comprises glass fibers or a plastics material.
